(19) United States
(12) Patent Application Publication
(10) Pub. No.: US 2002/0134318 A1
(43) Pub. Date: Sep. 26, 2002

(54) Squeezable toy with sound-emitting device

(76) Inventors: Charles D. Mann, Burnsville, MN (US); Raymond J. Hedlund SR., Concord, CA (US)

Correspondence Address: Robert M. Angus, Westman, Champlin & Kelly, International Centre, Suite 1600, 900 Second Avenue South, Minneapolis, MN, 55402-3319, US

(21) Appl. No.: 10/152,410

(22) Filed: May 21, 2002

Related U.S. Application Data
(63) Continuation-in-part of application No. 09/781,205, filed on Feb. 12, 2001.

(51) Int. Cl. A01K 29/00

(52) U.S. Cl. 119/709

(57) ABSTRACT

A toy comprises a three-dimensional body that can be compressed to actuate a squeaker chamber to move air through a squeaker device. In one form a slot forms an air passage between the outside of the toy and the squeaker chamber, and a squeaker is mounted in the slot recessed from the surface so it is not easily accessible. The slot may be arranged with a length that is long compared to the length of the squeaker, with the squeaker mounted adjacent the squeaker chamber. Alternatively, a treat-retaining cavity may form an opening between the slot and the outer surface of the toy. In other embodiments squeaker chamber is formed by an elongated resilient member in the toy body that can be actuated to operate the squeaker device for a location on the toy distal from the squeaker device. Various combinations of couplers and squeaker devices result in a variety of squeaker system configurations for a variety of toy shapes.

### CROSS-REFERENCE TO RELATED APPLICATION

This application is a continuation-in-part of application Ser. No. 09/781,205 filed Feb. 12, 2001 for “Pet Toy” by Charles D. Mann, incorporated herein by reference.

### BACKGROUND OF THE INVENTION

This invention relates to squeezable toys, and particularly to non-consumable chewable pet toys having sound-emitting devices for carnivorous animals such as dogs and cats.

Non-consumable chewable pet toys provide a variety of beneficial functions for the pet carnivore. Chewing on such toys provides the carnivore with masticatory exercise, as well as dental prophylaxis. Irregular shapes impart erratic movements to the toy when rolled or bounced, thereby providing exercise for the animal. Such toys often provide a training function, teaching the carnivore to chew on the toy, rather than on furniture or other valuable items.

To enhance the attractiveness of the toy to the carnivore, sensory attractants have been incorporated in the toy. These toys attract the carnivore and encourage the carnivore to chew on the toy, rather than on furniture or other personal property. Thus, the sensory attractant is particularly advantageous as a training device for the carnivore.

One attractant commonly employed in chewable pet toys is a noise-producing device that emits a squeak or other attractant sound due to air flowing through the device when the carnivore chews on the toy. Such a noise-producing device, commonly called a “squeaker”, usually comprises a small rigid housing, usually constructed of plastic, forming a passage containing a reed or other acoustic vibrating device that emits a sound when air passes through the passage. The squeaker is ordinarily mounted in an external wall of the toy so that compression of a squeaker chamber within the toy, such as by chewing by the carnivore, forces air through the passage to emit a sound. Upon relaxation of the squeaker chamber, the chamber returns to its relaxed, or inflated, state, drawing air through the squeaker passage and again emitting a sound. In most cases, the squeaker chamber is integral with the toy, although in some cases the squeaker device includes its own chamber. In either case, the squeaker chamber is closed so that the squeaker passage forms the only passage for air into and out of the chamber. The squeaker, and its associated squeaker chamber, are ordinarily confined to a small region of the toy.

Most carnivorous animals are attracted by the sound from the squeaker to chew on the chew toy at the region of the squeaker device. Consequently, most animals tend to chew at only the location of the squeaker in the toy, eventually tearing or rupturing the toy at that location. When the toy tears or ruptures at the region of the squeaker, a risk exists that the animal will dislodge the rigid squeaker housing from the toy and will swallow the squeaker, possibly injuring the animal.

Another sensory attractant used in pet toys comprises a replaceable edible attractant, such as a dog biscuit, held by the toy to attract the animal. One such pet toy for retaining a replaceable edible attractant is marketed by Mann Design and described in the aforementioned Mann application. The Mann Design toy employs a trapper cavity extending through the toy and an adjacent bias cavity that provides independent flexibility to a bias wall of the trapper cavity. The attractant is easily inserted into the trapper cavity by deforming the bias wall into the bias cavity. Upon release of the deforming force, a substantial portion of the surface area of the attractant is clamped between the opposing walls of the trapper cavity. Hence, the Mann Design toy provided easy replacement of the attractant, while holding the interest of the animal for a substantial period of time.

### BRIEF SUMMARY OF THE INVENTION

The present invention is directed to a non-consumable toy having a squeaker arranged in such a manner as to provide increased interest to the user. In preferred embodiments, the squeaker is hidden from the user, such as by recessing the squeaker from the external surface of the toy, or placing the squeaker at a location in the toy remote from the squeaker chamber. In either case, the risk that the animal will dislodge the squeaker from the toy is minimized.

In one embodiment, a toy includes a squeaker chamber having at least a portion arranged within the toy distal from the squeaker device so that the sound is emitted from a location of the toy different from the location of the squeaker device. The squeaker chamber is in the form of one or more elongated resilient tubes that together or independently operate one or more squeaker devices.

In another embodiment, a toy comprises a three-dimensional body formed of resilient material. A squeaker chamber in the body has a nominal size when the body is in a relaxed condition and is collapsible due to deformation of the body. A slot forms an air passage between a region outside of the toy and the squeaker chamber so that upon deformation of the body and upon relaxation of the body from a deformation condition, air passes through the slot. A squeaker device is mounted in the slot and recessed from the outer surface of the toy so that the squeaker device is not readily accessible by the animal.

In some embodiments, the body includes a cavity having an opening to the outer surface to the cavity, and the slot extends between the squeaker chamber and the cavity. The cavity is arranged to retain a replaceable attractant, such as a dog biscuit, so that the cavity serves as an attractant-retaining cavity and as an air passage for the squeaker.

### BRIEF DESCRIPTION OF THE DRAWINGS

FIG. 1 is a perspective view of a pet toy described in the aforementioned Mann application illustrating the principles of the pet toy for retaining a replaceable attractant.

FIGS. 2 and 3 are front and section views, respectively of the pet toy illustrated in FIG. 1.

FIG. 4 is a frontal view as in FIG. 2, illustrating the application of force and distortion of the toy to permit insertion of a replaceable attractant.

FIGS. 5 and 6 are a perspective view and assembly view, respectively, of a first embodiment of the present invention.

FIG. 7 is a section view of a simple squeaker system according to a second embodiment of the present invention.

FIGS. 8-10 are views of various coupler devices useful in squeaker systems in various configurations of toys according to the second embodiment of the invention.

FIGS. 11-18 are views of various embodiments of toys employing squeaker systems using various couplers of FIGS. 8-10.

### DETAILED DESCRIPTION

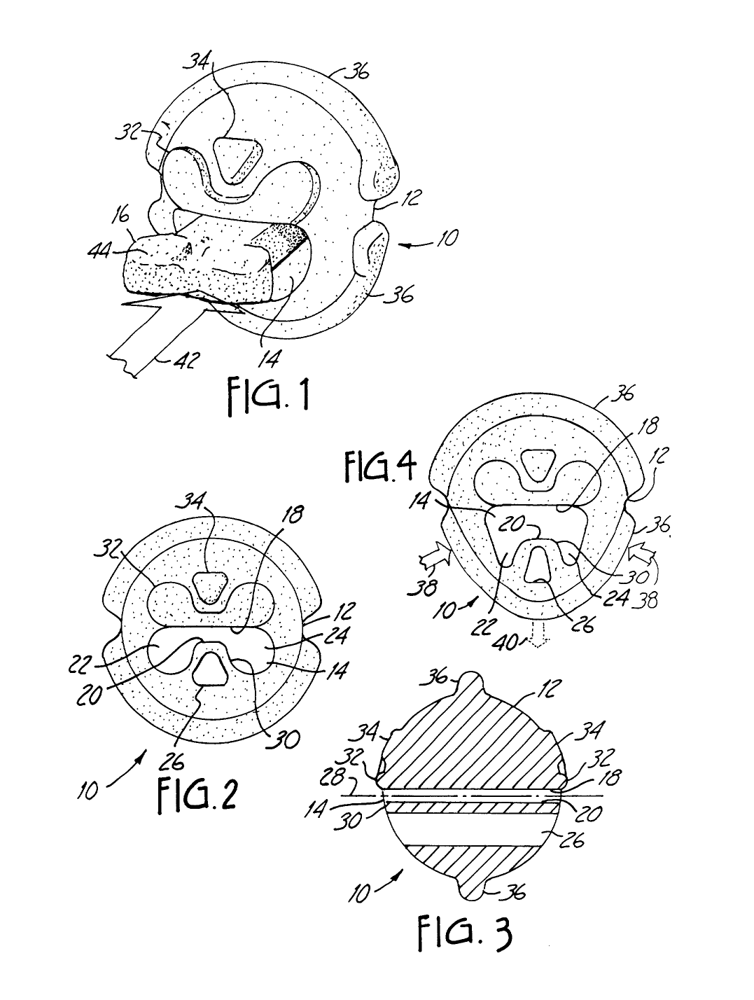

Most replaceable animal attractants, such as dog biscuits and the like, have relatively low shear strengths. Such attractants cannot support shear loads and therefore cannot be easily twisted into a pet toy without breaking. Nevertheless, such attractants often have relatively high compression strengths, such that they can support compression loads. The pet toy described in the aforementioned Mann application takes advantage of the relatively high compression strength of the attractant and is particularly directed to a pet toy wherein the attractant is inserted under a compression force, and is held by the toy under a compression force. FIGS. 1-4 illustrate a pet toy 10 described in the aforementioned Mann application. Trapper cavity 14 extends through body 20 and is open at each end thereof to accept a replaceable sensory attractant 16, such as a dog biscuit, to be held within trapper cavity 14. Trapper cavity 14 has opposing walls 18 and 20 that are spaced apart by distance smaller than the thickness of sensory attractant 16 when the body of the toy is a relaxed condition. End portions 22 and 24 form terminations for walls 18 and 20 terminate at opposite sides of cavity 14 across the width of the cavity; end portions 22 and 24 extending somewhat away from wall 18 as shown to define a neck portion between walls 18 and 20. Thus, trapper cavity 14 is generally in the shape of a half-bone with a narrow neck portion between walls 18 and 20.

A bias cavity 26 in the form of an aperture extends through body 12 parallel to axis 28 of trapper cavity 14. Aperture 26 forms a bias member 30 in the form of a continuous bridge between aperture 26 and trapper cavity 14. The bridge extends adjacent the neck between walls 18 and 20, as well as adjacent one side of enlarged end portions 22 and 24.

Protrusion 32, generally in the shape of a half-bone similar to trapper cavity 24, is formed on opposite surfaces of body 12 adjacent the openings of the longer wall 18 of the trapper cavity. Protrusion 34, generally in the shape of bias aperture 26, is formed on opposite surfaces of body 12 to provide symmetry to the bias aperture. Protrusions 32 and 34 are provided for aesthetic purposes and to aid in imparting erratic movements to the toy when rolled or bounced. A pair of protrusions 36 are formed about the periphery of the body, each in the shape of a bone, encircling the openings of cavity 14, again enhancing the aesthetics of the toy, as well as providing an irregular shape to the toy to impart erratic movements of the toy when rolled or bounced.

Insertion of sensory attractant 16 into the trapper cavity of the toy may best be explained with particular reference to FIGS. 1, 2 and 4. FIG. 2 is a frontal view of the toy in a relaxed condition, without a replaceable attractant in cavity 14. A force is applied to the body of the relaxed toy in the direction of arrows 38 (FIG. 4), such as by squeezing between the thumb and fingers of one hand of the pet master. The force deforms body 12 and trapper cavity 14 in the direction of arrow 40, thereby increasing the space between walls 18 and 20 of trapper cavity 14 and decreasing the width of the cavity. Enlarged portions 22 and 24 also deform as shown, making easy the insertion of attractant 16. Attractant 16 is then inserted into the opened cavity and urged by hand in the direction of arrow 42 (FIG. 1) axially into cavity 14. With the attractant fully inserted in cavity 14, the force of arrows 38 is released, allowing the body of the toy to relax, resulting in walls 18 and 20 compressing against external surfaces 44 of the attractant, retaining the attractant under the compressive force of the relaxed body. Thus, the body is sufficiently flexible to permit compression along the width of cavity 14 and expansion across cavity 14 to permit easy insertion of the attractant. The bias aperture serves to bias bridge 30 against the attractant to retain the attractant in the cavity.

In use, the carnivore chews on the toy in an attempt to loosen and obtain the attractant, thus providing the carnivore with masticatory exercise, as well as dental prophylaxis. The inclusion of the sensory attractant is particularly advantageous as a training device, encouraging the carnivore to chew on the toy, rather than on furniture or other valuable items. Should the animal push or bounce the toy, protrusions 36 assure an erratic movement to the toy upon bouncing or rolling thereby providing exercise for the animal.

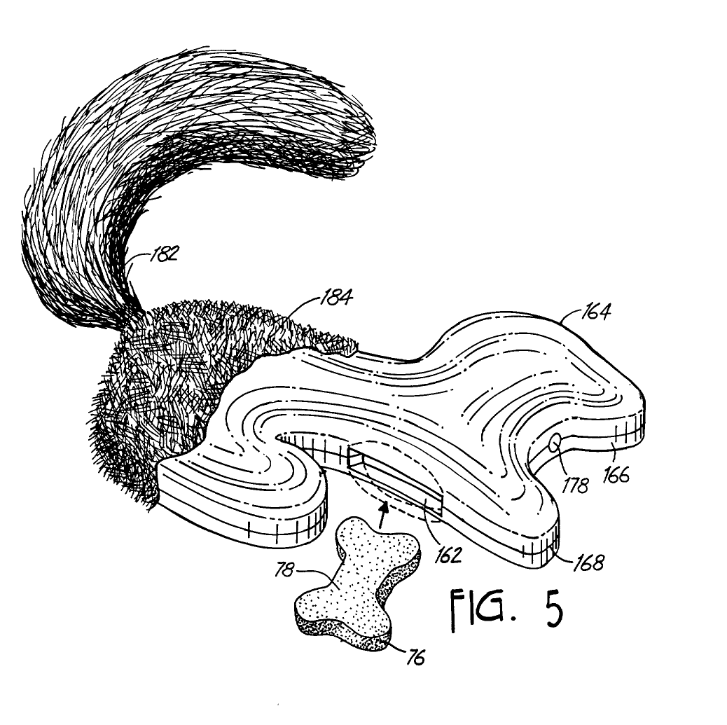

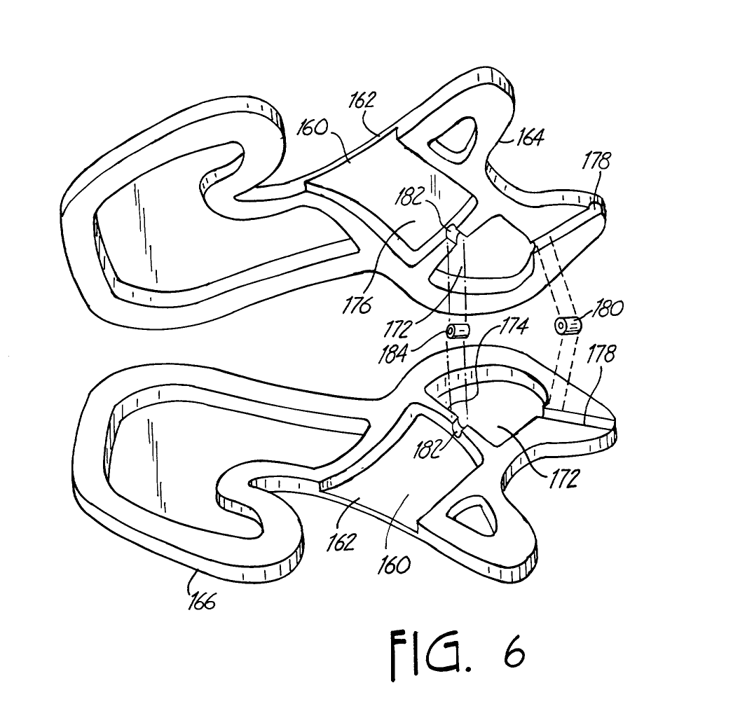

FIGS. 5 and 6 illustrate a first embodiment of the present invention in which the toy resembles an animal, in this case a squirrel, and includes a trapper cavity 160 having an opening 162 in a peripheral wall of the toy. Resilient members 164 and 166 are fastened together with an adhesive 168. In this case, internal walls 170 divide the assembled toy into trapper cavity 160 and one or more chambers 172. Trapper cavity 160 is sized so that opposing walls 176 of cavity 160 engage and clamp against substantial portions of opposite surfaces 78 of attractant 76 to hold the attractant in the cavity. The peripheral wall of the toy includes opening 162 to trapper cavity 160 to permit insertion of the attractant 76. One chamber 172, separate from the attractant-retaining trapper cavity 160, is a squeaker chamber formed by members 164 and 166 that includes a slot 178 in which a squeaker or other suitable noise-producing member 180 may be placed and sealed to the body with adhesive 168. Trapper cavity 160, squeaker chamber 172 and slot 178 are formed between body members 164 and 166, and squeaker 180 in slot 178 is sandwiched between the body members. To complete the illusion that the toy illustrated in FIGS. 5 and 6 is an animal, such as a squirrel, a tail 182 may be added and the entire body may be covered with a fur-like material 184.

As shown particularly in FIG. 6, squeaker 180 is recessed from the outer surface of the toy in slot 178 so that the animal can not chew the squeaker loose from the toy. Thus, the length of slot 178 is at least twice, and preferably, three times the length of squeaker 180 and squeaker 180 is mounted in slot 178 at or near the entrance to chamber 172 so that the squeaker is recessed from the outer surface of the toy by a distance at least as great as its length, and preferably as much as twice its length. Alternatively, squeaker-retaining slot 182 may be formed between squeaker chamber 172 and trapper cavity 160 so that squeaker 184 may be placed in slot 182, out of reach by the animal. Placement of the squeaker between the squeaker chamber and the trapper cavity places the squeaker in close proximity to the treat in the trapper cavity, so the animal is attracted to that region of the toy by both the treat and the squeaker.

Squeaker chamber 172 is a sealed chamber such that air may be introduced or expelled from chamber 172 only through the squeaker. Chamber 172 is collapsible due to deformation of the body of the toy at the squeaker chamber to expel air from chamber 172 through squeaker 180 and slot 178 to the outside of the toy, or through squeaker 184 and slot 182 to trapper cavity 160 and the outside of the toy. In either case, squeaker chamber 172 is expandable to its nominal size upon subsequent relaxation of the body to its normal shape to draw air into the squeaker chamber through the squeaker and slot. Hence, each time the animal bites on the body at the squeaker chamber, or releases it, air passes through the squeaker producing a noise.

Replaceable attractant 76, such as a biscuit or the like, is retained and clamped in the attractant-receiving trapper cavity over a substantial portion of the opposing surfaces 78 of the attractant. Preferably, the treat-retaining trapper cavity is designed to clamp the attractant to engage at least about one-half of the length of ordinary biscuits, such as MilkBone® biscuits. In some cases, however, the owner or handler may choose to insert a lesser portion of the attractant. The toy shown in FIGS. 5 and 6 releases the replaceable attractant over a long period of time, thereby holding the interest of the animal. Additionally, since the attractant can be inserted with minimum difficulty, the toy is easy to use without breaking the attractant.

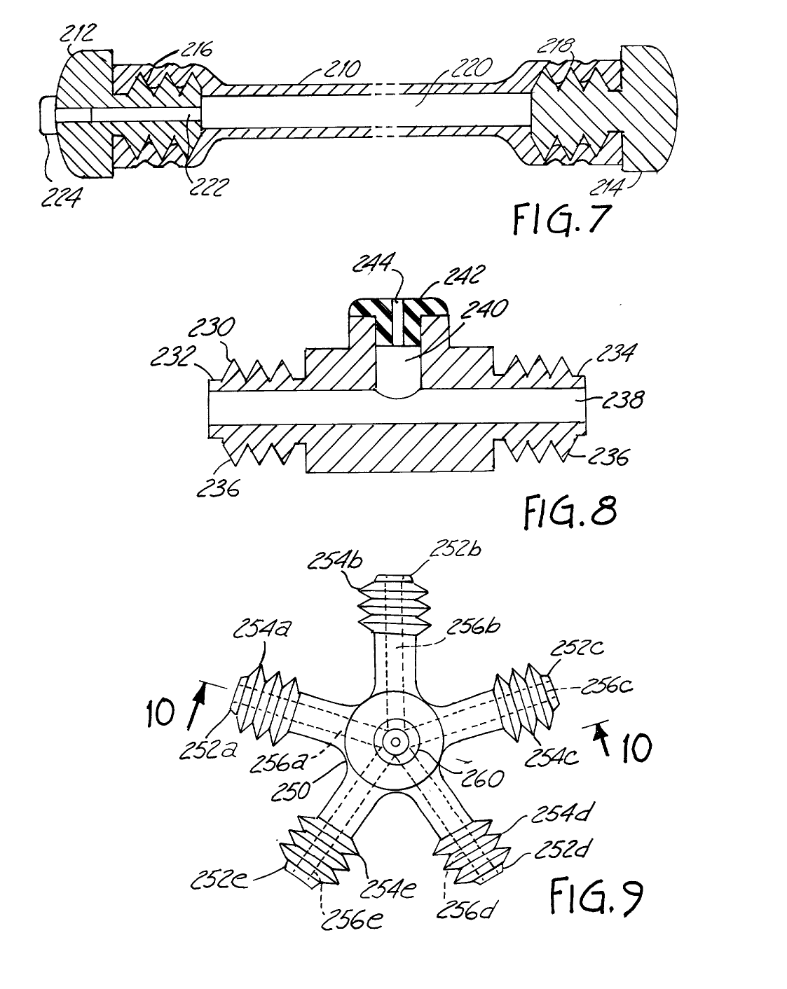

In the embodiment of FIGS. 5 and 6, squeaker 180 or 184 is inaccessible to the animal by being recessed in the toy from the external surface of the toy. Consequently, the risk that the animal can or will dislodge the squeaker from the toy is minimized. In the embodiments of FIGS. 7-18, the squeaker is inaccessible to the animal by being “hidden” in the toy at a location remote from the region of the squeaker actuation chamber.

FIG. 7 is a section view of a squeaker and squeaker chamber system illustrating the principles of certain embodiments of the present invention. The squeaker system illustrated in FIG. 7 comprises an elongated flexible and resilient hollow tube 210 having rigid plugs 212 and 214 closing each end of tube 210. Plugs 212 and 214 include serrations 216 and 218 having a slightly larger diameter than the inside diameter of tube 210 so that the plugs are mounted to and retained by the tube to form an enclosed squeaker chamber 220 within the tube. One of the plugs, for example, plug 212, includes a slot or aperture 222 extending axially through the plug. Squeaker device 224 is mounted in aperture 222. The squeaker device includes a passage and a vibrating member (not shown) to produce a noise as air passes through the squeaker passage into and out of chamber 220. If the tube is formed of a plastic or other material that seals upon itself by application of heat or other treatment, the end of the tube may be sealed by so treating the tube instead of by plug 214.

In preferred embodiments, tube 210 is sufficiently flexible so that it may be twisted and manipulated into various configurations and held in place within the toy. The tube is sufficiently resilient so that collapse or compression of at least a portion of its cross-section upon application of an external force to the tube will reduce the volume of chamber 220 and thereby expel air through squeaker 224. The resilience of tube 210 also permits the tube to return to its relaxed cross-sectional shape upon release of the external force, thereby drawing air through squeaker 224 into chamber 222. The ease of collapsing or compression of the tube should be adequate for the expected external force, such as the biting action of a carnivore (in the case of a pet toy) or pressing by a child (in the case of a child's toy). The expected external force will be based on the size of the toy, which in turn is based on the weight of the animal or age of the child, as the case may be. Tube 210 may be of any desired cross-sectional shape. In some embodiments the tube may have a cross-sectional shape and/or wall thickness that varies along its length. Nevertheless, tubes having a circular cross-section are preferred due to availability and the natural tendency of a circular tube to return to its circular cross-sectional shape upon release of the external force.

The length of tube 210 is not controlling on the present invention, since it is not necessary that the entire tube be collapsed for purposes of operating squeaker 224. Instead, it is only important that a portion of the tube be collapsed to operate the squeaker. We have found that ordinary surgical tubing having an inside diameter between about 0.4 and 0.5 inches and wall thickness of approximately 0.1 inches, is adequate for the present purposes.

It is important that tube 210 be long enough to extend distally from squeaker device 224 so that the squeaker device may be positioned at a desired location within the toy and operated by squeezing the tube (such as when the animal bites the toy) at another location of the toy distal from the squeaker device. For example, a squeaker system in a toy having an animal or figurine shape might incorporate a squeaker system wherein the squeaker device 224 is positioned in the head of the figure and tube 210 extends through the body to the arms and legs. As will become apparent in connection with the embodiments of FIGS. 12 and 13, the toy may have a more regular geometric shape, such as a ball, disk or ring, wherein the squeaker system is configured to permit squeezing or biting the toy at nearly any location to produce a sound at the one location of the squeaker device.

When the animal bites at a location of a toy containing a portion of tube 210, air will be expelled from chamber 220 through squeaker 224 to produce a noise. The noise will be produced by squeaker 224 regardless of where the animal bites along the length of tube 210. However, should the animal bite on the toy at the location of rigid plug 214 or 212 (i.e., at the location of squeaker 224), or so near a rigid plug that the rigidity of the plug body prevents collapse of the tube, the tube is not collapse and air is not expelling from squeaker chamber 220 and no sound is emitted.

FIGS. 8-11 illustrate various couplers for the squeaker system that may be employed to create squeaker systems for various toys. FIG. 8 illustrates a rigid coupler 230 having arms 232 and 234, each having external serrated portions 236 for attachment within ends of respective tubes or tube sections 210 (not shown in FIG. 8). An internal passage 238 extends through coupler 230 and arms 232 and 234. Aperture 240 extends perpendicularly to passage 238 to receives a squeaker 242 having a squeaker passage 244 containing a reed (not shown) or other noise-making device.

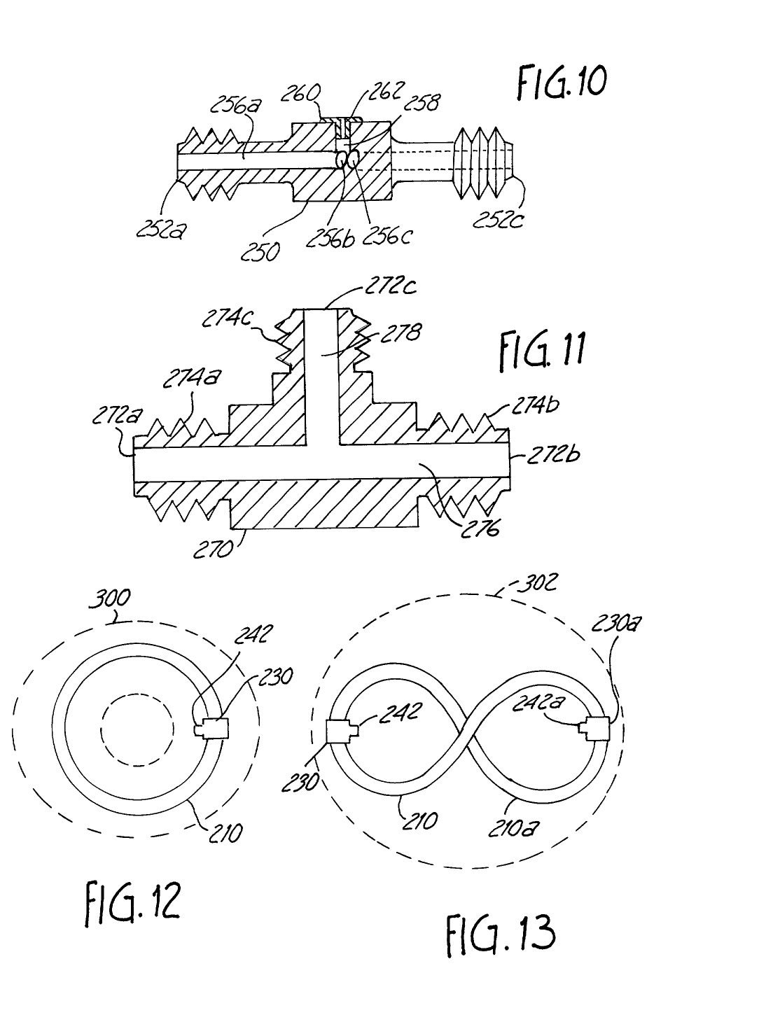

FIGS. 9 and 10 illustrate a rigid coupler 250 having a plurality of arms, 252a-e, each having serrated portions 254a-e each arranged to receive a respective end of a tube 210. Coupler 250 is shown having five arms 252a-e symmetrically arranged at 72° angles to each other around a central point, but the number of arms and symmetry of arrangement of the arms may vary, depending upon the particular application of the coupler. Each arm 252a-e includes an axial passage 256a-e terminating at central aperture 258 (shown in FIG. 10) extending perpendicularly to passages 256a-e. Squeaker 260 is supported within aperture 258 so that air may be expelled from, or admitted into internal passage 262 of squeaker 260 to transfer air between one or more of passages 256a-e upon collapsing or relaxing of an associated tube 210 (not shown in FIGS. 9 and 10).

FIG. 11 illustrates a rigid coupler 270 having three arms 272a-c in the form of a tee, each having serrated coupling portions 274a-c for coupling to ends of tubes 210 (not shown in FIG. 11). In this version, coupler 270 has no squeaker, and is used with other couplers or plugs, such as plug 212 (FIG. 7) and/or couplers 230 and/or 260 (FIGS. 8-10). Coupler 270 includes a passage 276 extends through arms 272a and 272b, intersecting passage 278 through arm 272c. Coupler 270 permits coupling three tubes 210 together in a single configuration.

FIG. 12 illustrates a compressible ring or disk toy 300 having a squeaker system in the form of a ring employing coupler 230 (FIG. 8) and tube 210. Toy 300 is formed in a conventional manner comprising a flexible cover, such as fabric or artificial fur, encasing a compressible filler material, such as synthetic foam rubber. The squeaker system is held within the toy by the filler material, such as by nesting the squeaker system in the toy. In this case, opposite ends of tube 210 are coupled to serrated portions 236 of arms 232 and 234 of coupler 230 to form a ring. Squeaker 242 is supported by coupler 230, and is preferably oriented toward the center of the ring and remote from the external surface of the toy to minimize the ability of the animal to access the squeaker to dislodge the squeaker from the toy. When the animal bites on any portion of toy 300 containing tube 210, other than directly on coupler 230 and squeaker 242, tube 210 will be compressed at the region of the bite and expel air through squeaker 242 to emit a sound. Upon release of the bite by the animal, tube 210 will return to its relaxed state, drawing air back through squeaker 242 into the chamber, thereby producing another noise.

FIG. 13 illustrates a compressible spherical ball 302 containing a pair of tubes 210 and 210a coupled together by two couplers 230 and 230a (FIG. 8), each having an independent squeaker 242 and 242a. Ball 302 is constructed in a manner similar to toy 300. In this case, when the animal bites on ball 302, collapsing either or both tubes 210 and 210a, air will expel through one or both squeakers 242 and 242a, thereby generating noise by the respective squeakers. Upon release of the bite by the animal, air will be drawn back into tubes 210 and/or 210a through squeakers 242 and/or 242a, thereby producing another noise.

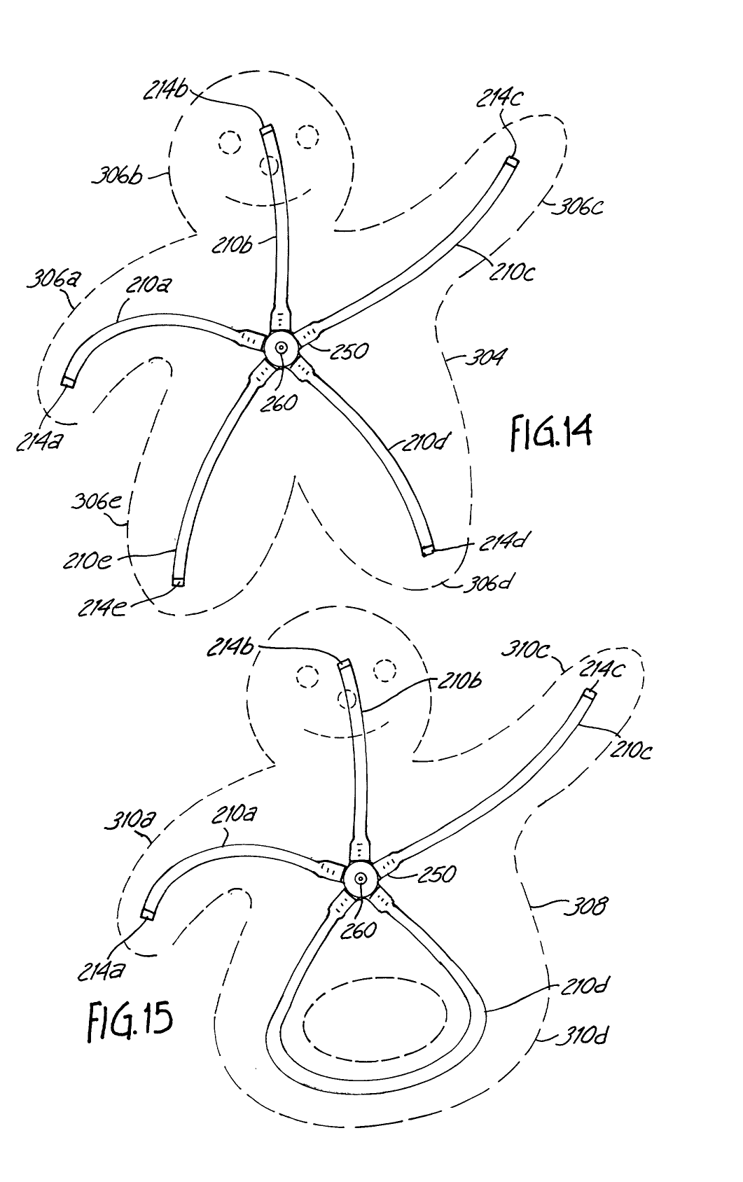

FIG. 14 illustrates another compressible toy 304 in the form of a figurine or doll. Toy 304 is constructed in the same manner as toys 300 and 302. Toy 304 has extremities 306a-e representing a head, arms and legs of the figure. A tube 210a-e extends along the length of each respective extremity 306a-e terminating at a distal end by a respective plug 214a-e (FIG. 7). The proximal end of each tube 210a-e is coupled to respective arms of coupler 250 (FIGS. 9-10). When the animal bites toy 304 at the location of any tube 210a-e, air is displaced from the associated squeaker chamber and is expelled through squeaker passage 263 in squeaker 260 (FIG. 10), thereby emitting a sound. The sound is emitted from the squeaker at a central location on the toy regardless of which tube 210a-e is collapsed or compressed, or where on that tube such collapsing occurs. When the animal releases the toy, and hence the tube, air returns through squeaker 260 into the squeaker chamber of the previously compressed tube 210a-e, causing the squeaker to emit another sound. Thus, the animal may bite onto any extremity 306a-e of the toy to create a sound at the central location. However, because coupler 250 and squeaker 260 are rigid, biting at a central location on the toy will not produce a sound.

FIG. 15 illustrates a modification of the toy illustrated in FIG. 14 wherein toy 308 includes extremities 310a-d, with extremity being ring-shaped. Tubes 210a-c extend distally of coupler 250 within extremities 310a-c, the distal end of each tube 210a-c being closed with a plug 214 (FIG. 7). Tube 210d extends through the ring-shaped extremity 310d and has its ends joint to two arms of coupler 250, such as arms 252d and 252e (FIG. 9).

If desired, the passage in one of the arms of coupler 250 coupled to tube 210d might plugged or constricted so that air flows to and from the ring-shaped tube 210d from only one of the arms. Thus, passage 256e (FIG. 9) in arm 252e might be constricted so all air to and from tube 210d flows through passage 256d in arm 252d.

FIG. 16 illustrates another modification of the toy illustrated in FIG. 14 wherein toy 312 has extremities 314a-e, similar to extremities 306a-e in FIG. 14, but wherein a ring-shaped squeaker cavity is employed in one of the extremities, such as extremity 314b representing the head of the figure. In this case, the distal end of tube 210b terminates in a tee-coupler 270 (FIG. 11) rather than a plug, and a tube 210f is coupled in a ring to the opposite arms of coupler 270 forming a ring-shaped squeaker chamber.

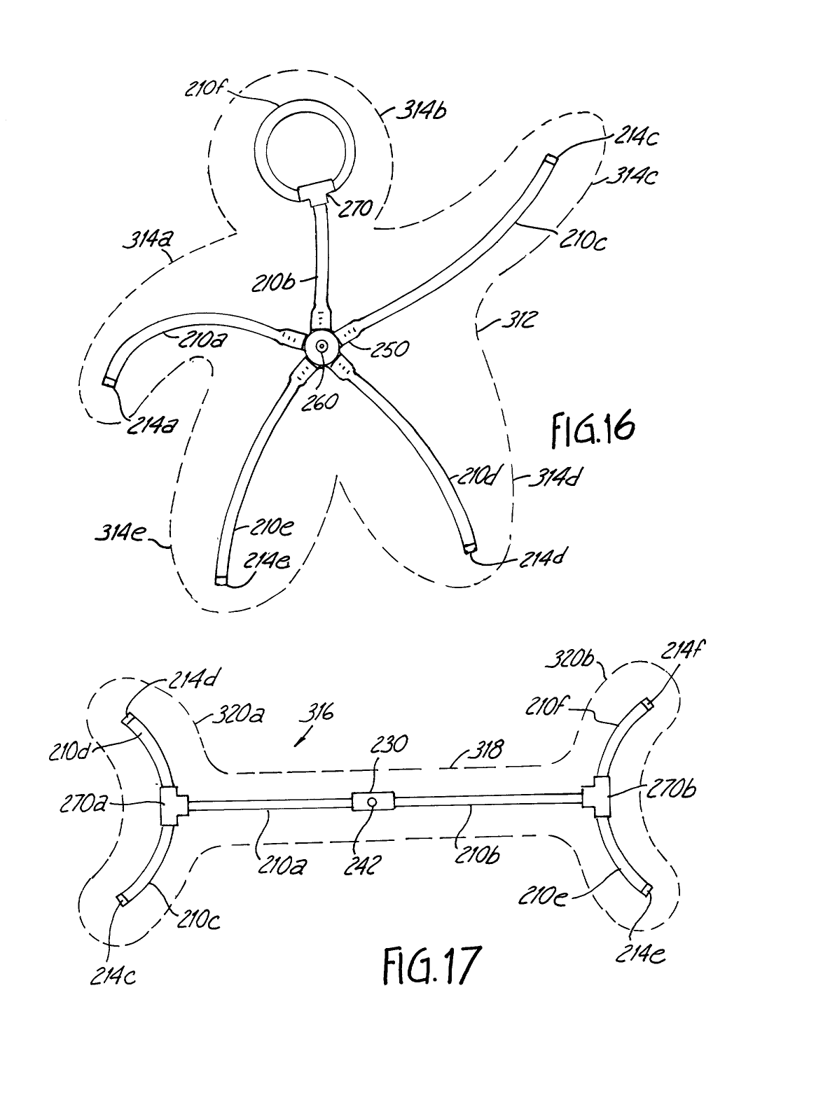

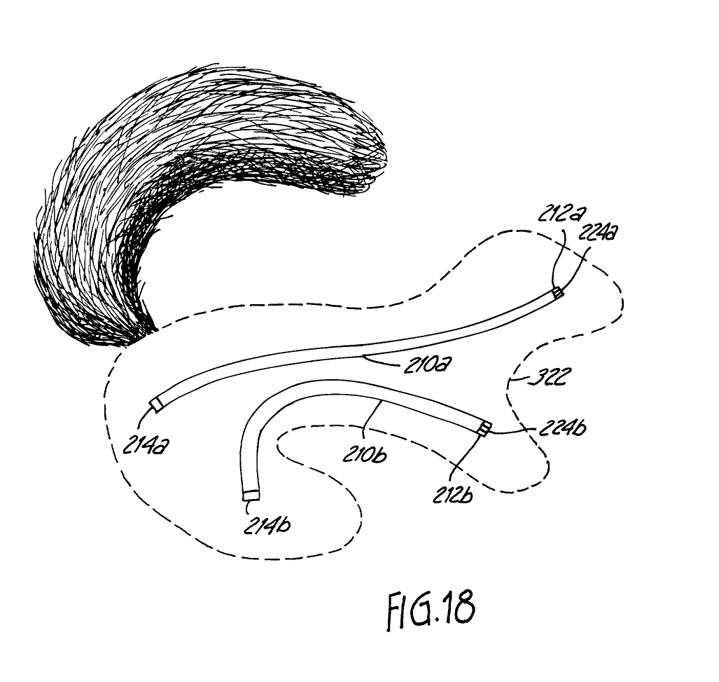

FIG. 17 illustrates another embodiment of a compressible toy 316 constructed in a manner similar to toys described above. Toy 316 is in the shape of a bone having a neck portion 318 joining two head portions 320a and 320b. Coupler 230 (FIG. 8) has a squeaker 242 arranged such that coupler 230 and squeaker 242 are at a central location in the neck of bone 316. Tubes 210a and 210b extend from opposite sides of coupler 230 to respective tee-couplers 270a and 270b (FIG. 11). Tubes 210c-f extend from respective couplers 270a or 270b into the heads 320a and 320b of bone 316 and are sealed with plugs 214c-f (FIG. 7). As in the case of the embodiments of FIGS. 12-16, when the animal bites onto a tube 210a-f at a location remote from coupler 230 and squeaker 242, air is expelled through the squeaker to emit a sound from toy 316. Upon release of the bite, air is again admitted through the squeaker to again produce a sound.

FIG. 18 illustrates another embodiment of the invention wherein a compressible toy 322, similar to the toy shown in FIGS. 5 and 6, employs a pair of squeaker systems as illustrated in FIG. 7. Toy 322 is constructed in the same manner as described in connection with the toys of FIGS. 12-17 and includes a first squeaker system having a tube 210a terminating at one end with plug 212a containing a squeaker 224a and at the other end with closed plug 214a. A second squeaker system comprises tube 210b terminating at one end with plug 212b having a squeaker 224b and at the other end with closed plug 214b. Squeakers 224a and 224b may be chosen for different sound characteristics and arranged at different locations of toy 322. Tubes 210a and 210b may extend through different regions of toy 322 so that the animal generates one sound or the other depending on which region of toy 322 the animal may bite. Alternatively, tubes 210a and 210b may be in close proximity so the animal produces both sounds by biting the toy to compress both tubes 210a and 210b. As another alternative, a single tube could be used in place of tubes 210a and 210b, with a seal, such as a heat seal, crimping a central portion of the tube, so that a different sound is produced depending on what portion of the tube is squeezed. If desired, the tubes may be arranged so that the squeakers are in the same location within the toy so that a different sound emits from a single location, such as the head of the toy, depending on what region of the toy the animal bites.

The present invention thus provides a squeaker system for a squeezable toy, such as an animal or child's toy, wherein the squeaker device is positioned remote from the surface of the toy so that it cannot be easily accessed or pried loose by the animal or child playing with the toy. In one embodiment, the toy includes a three-dimensional compressible body 164, 166. A squeaker chamber 172 in the body is collapsible due to compression of the adjacent body. An elongated slot 182, 178 forms an air passage between the outside of the toy and the squeaker chamber. A squeaker device 184, 180 emits a sound when air passes through the squeaker device. The squeaker device is mounted in the slot recessed from the outer surface of the toy and arranged relative to the squeaker chamber that when the toy body is compressed adjacent the squeaker chamber, air is expelled from the squeaker chamber through the squeaker device. In other embodiments, the squeaker is “hidden” from the animal by employing an elongated squeaker chamber in the body, so that that when the toy body is compressed adjacent a portion of the squeaker chamber distal from the squeaker device, air is expelled from the squeaker chamber through the squeaker passage.

One feature of the embodiments of FIGS. 7-18 is that should the animal bite on the toy at the location of a rigid plug or coupler (i.e., at the location of a squeaker device), or so near a rigid plug or coupler that the rigidity of the plug or coupler body prevents collapse of the tube, the tube will not collapse due to biting by the animal, so air is not expelled from the squeaker chamber and no sound is emitted. Consequently, if the animal is attracted by the sound of the squeaker device to bite the toy at the squeaker device, no sound will occur. This feature has the effect of increasing the interest of the animal in the toy and minimizing tear or rupture of the toy at the squeaker location due to chewing by the animal. Moreover, if plural squeaker devices or plural squeaker systems are employed, with each squeaker device emitting a different sound, the interest of the animal is raised even further. The region of non-operation of the squeaker device may be enlarged by employing coupler arms and plugs of extended length. This feature increases the area around the squeaker device where biting or chewing by the animal will not produce a sound, thereby limiting the sound-producing regions of the toy to regions remotely distal to the squeaker device, such as the extremities of an animal-shaped toy.

In the case of a child's toy, the squeaker device may be place at a desired location such as within the head of a doll or other figurine, and the active portion of the squeaker chamber is located adjacent regions of the toy ornamented for pressing by the child. This feature increases hand-eye coordination of the child by training the child to press the toy at a specific location other that at the squeaker device.

It will be appreciated that while the invention is described in connection with pet toys, it is also applicable to other toys, including children's toys. More particularly, the recessed squeaker device distal from the outer surface of the toy is particularly useful in children's toys as a safety feature. Moreover, the use of elongated resilient members 210 to remove the actuation portion of the squeaker chamber from the squeaker device can serve as a child's training device to promote hand/eye coordination, rewarding the child with a sound from a different location on the toy from that which the child might press or squeeze.

Although the present invention has been described with reference to preferred embodiments, workers skilled in the art will recognize that changes may be made in form and detail without departing from the spirit and scope of the invention.

1. A toy for a user comprising:
a three-dimensional compressible body;
at least one squeaker device supported within the body; and
means, including a compressible squeaker chamber, for operating the squeaker device while rendering the squeaker device inaccessible to the user.

2. The toy of claim 1, wherein the body has an outer surface, and the means operating the squeaker device includes:
an elongated slot forming an air passage between the outside of the toy and the squeaker chamber, the slot having a length that is long compared to a length of the squeaker, and
the at least one squeaker device is mounted in the slot adjacent the squeaker chamber and recessed from the outer surface.

3. The toy of claim 1, wherein the body has an outer surface, and the means operating the squeaker device includes:
an attractant-retaining cavity in the body,
at least one opening in the outer surface to the cavity,
a slot extending between the squeaker chamber and the cavity, and
the at least one squeaker device is mounted in the slot adjacent the squeaker chamber and recessed from the outer surface.

4. The toy of claim 1, wherein means operating the squeaker device includes:
an elongated squeaker chamber in the body, at least a portion of the squeaker chamber being collapsible due to compression of at least a corresponding portion of the body, and
the at least one squeaker device is mounted to the squeaker chamber and so disposed and arranged relative to the squeaker chamber that when the body is compressed at a region distal from the squeaker device and adjacent at least a portion of the squeaker chamber, air is expelled from the squeaker chamber to operate the squeaker device.

5. The toy of claim 4, wherein means operating the squeaker device further includes:
a coupler having
a plurality of arms, and
an air passage through at least two of the arms,
the squeaker device being mounted to the coupler and arranged so that the squeaker passage is in fluid communication with the air passage, and
the squeaker chamber being coupled to each of the arms.

6. A toy comprising:
a three-dimensional compressible body having an outer surface;
a squeaker chamber in the body, at least a portion of the squeaker chamber being collapsible due to compression of at least a corresponding portion of the body;
an elongated slot forming an air passage between the outside of the toy and the squeaker chamber; and
at least one squeaker device that emits a sound when air passes through a squeaker passage in the squeaker device, the at least one squeaker device being mounted in the slot recessed from the outer surface and so disposed and arranged relative to the squeaker chamber that when the body is compressed at a region adjacent at least a portion of the squeaker chamber, air is expelled from the squeaker chamber through the squeaker passage.

7. The toy of claim 6, wherein the body comprises first and second resilient body members joined together so that the squeaker chamber and the slot are formed between the first and second body members and the at least one squeaker device is sandwiched between the first and second members.

8. The toy of claim 6, wherein the slot extends between the outer surface of the body and the squeaker chamber, and the slot has a length that is long compared to a length of the squeaker, and the squeaker is mounted in the slot adjacent to squeaker chamber.

9. The toy of claim 6, wherein the body has a shape generally resembling an animal body, and a material covering the toy body resembling an animal skin.

10. The toy of claim 6, further including a cavity in the body, and
at least one opening in the outer surface to the cavity,
the slot extending between the squeaker chamber and the cavity.

11. The toy of claim 10, wherein the cavity is an attractant-retaining cavity for retaining an edible attractant and the body includes
first and second opposing surfaces defining the cavity.

12. The toy of claim 11, wherein the at least one opening forms a passage through which the edible attractant may be inserted into the cavity, the at least one opening cooperating with the slot to permit passage of air to the squeaker.

13. A toy comprising:
a three-dimensional compressible body having an outer surface;
a resilient member in the body defining an elongated squeaker chamber, at least a portion of the squeaker chamber being collapsible due to compression of at least a corresponding portion of the body; and
at least one squeaker device that emits a sound when air passes through a squeaker passage in the squeaker device, the at least one squeaker device being mounted to the squeaker chamber and so disposed and arranged relative to the squeaker chamber that when the body is compressed at a region distal from the squeaker device and adjacent at least a portion of the squeaker chamber, air is expelled from the squeaker chamber through the squeaker passage.

14. The toy of claim 13, wherein the resilient member includes a resilient tube.

15. The toy of claim 13, further including:
a coupler having
a plurality of arms, and
an air passage through at least two of the arms,
the squeaker device being mounted to the coupler and arranged so that the squeaker passage is in fluid communication with the air passage, and
the resilient member being coupled to each of the arms.

16. The toy of claim 15, wherein the compressible body includes a central portion and a plurality of extremities extending from the central portion, and the coupler is supported in the central portion and the resilient member comprises a plurality of resilient tubes extending into each of the extremities.

17. The toy of claim 15, wherein the compressible body is in the form of a ring or disc and wherein the coupler has first and second arms and the resilient member comprises a resilient tube having a first end coupled to the first arm and a second end coupled to the second arm to form a ring within the body.

18. The toy of claim 15, wherein the compressible body is in the form of a sphere and wherein the coupler has first and second arms and the resilient member comprises a resilient tube having a first end coupled to the first arm and a second end coupled to the second arm to form a figure-8 pattern in the body.

19. The toy of claim 15, further including:
a second coupler having
a plurality of arms, and
an air passage through at least two of the arms,
a second squeaker device mounted to the second coupler and arranged so that the squeaker passage is in fluid communication with the air passage of the second coupler, and
the resilient member being coupled to each of the arms of the first-named and second couplers.

20. The toy of claim 15, wherein the resilient member comprises a plurality of resilient tubes each having a proximal end coupled to a respective arm of the coupler and a sealed distal end.
